(19) United States
(12) Patent Application Publication
(10) Pub. No.: US 2005/0237909 A1
(43) Pub. Date: Oct. 27, 2005

(54) Rewritable optical medium, apparatus for reading and/or for writing it and process for manufacturing a rewritable disc.

(76) Inventors: Maarten Kuijper, Dordrecht (NL); Ole K. Andersen, Eindhoven (NL); Jan M. Ter Meulen, Nijmegen (NL)

Correspondence Address: PHILIPS INTELLECTUAL PROPERTY & STANDARDS, P.O. BOX 3001, BRIARCLIFF MANOR, NY, 10510, US

(21) Appl. No.: 10/521,703

(22) PCT Filed: Jul. 8, 2003
(86) PCT No.: PCT/IB03/03142

§ 371 Date: Jan. 19, 2005

(30) Foreign Application Priority Data
Jul. 24, 2002 (EP) 02291874.2

(51) Int. Cl. G11B 7/24

(52) U.S. Cl. 369/275.2

(57) ABSTRACT

In this optical medium (1), a pre-groove track (5) which generates a tracking signal called PP signal, is embedded between layers (40 and 41) of material. This PP signal varies considerably between written and empty tracks. The reading and/or the writing can be disturbed to a large extent. An optical medium formed by a material which presents a slightly positive weak variation in the phase between written track and unwritten track and an average reflection coefficient of an order of magnitude of 0.5 or greater avoids this disturbance.

The present invention relates to an optical medium in which a pre-groove track is embedded for generating a tracking signal.

Such media are well known and find many applications, notably in the field of digital video recorders using re-writable optical discs. The recording and the erasing of data in this optical medium is based on the difference in reflection of the material which is brought to an amorphous state from a crystalline state by a powerful laser light and vice versa. On these discs, a pre-groove generates a tracking signal, which is usually called Push Pull (PP) signal. The Patent document EP-1 063 642 provides some information concerning the PP signal. This signal enables the tracking of the laser head for recording data onto or in the grooves of the disc and reading them from it. A Patent document, EP-1 143 430 gives information concerning such a medium. In this document, it is mentioned that the PP signal is affected by various parameters.

The applicant has found that in addition to these parameters, there is another one. It is the difference in behavior between the already written track and the unwritten track. With these different behaviors, the amplitude and the slope of the PP-signal vary strongly around the transitions between the written and the empty tracks. The servomechanism, which tracks the laser head, is disturbed to a large extent. The robustness of the tracking and the accuracy of the radial-tilt detector, which depend on the PP signal, are reduced. So, some perturbations may occur, which are unpleasant for the user.

The invention proposes an optical medium in which measures are applied such that the variations of the PP signals are reduced to a large extent.

Therefore, such a medium is characterized in that this material presents a slightly positive weak variation in the phase between a written track and an unwritten track and an average reflection coefficient equal to or greater than 0.5.

A main advantage of the invention is that the proposed measures are found to be well suited to the new generation of recording discs called Blue-ray Disc, which use a light having a short wavelength, but the invention also applies to other generations of optical discs using a laser with shorter or longer wavelength than blue.

Another advantage is that the performance of the push-pull amplitude-based tilt sensor is improved. Information concerning this tilt sensor can be found in patent document U.S. Pat. No. 6,157,600.

These and other aspects of the invention are apparent from and will be elucidated, by way of non-limitative example, with reference to the embodiment(s) described hereinafter.

In the drawings:

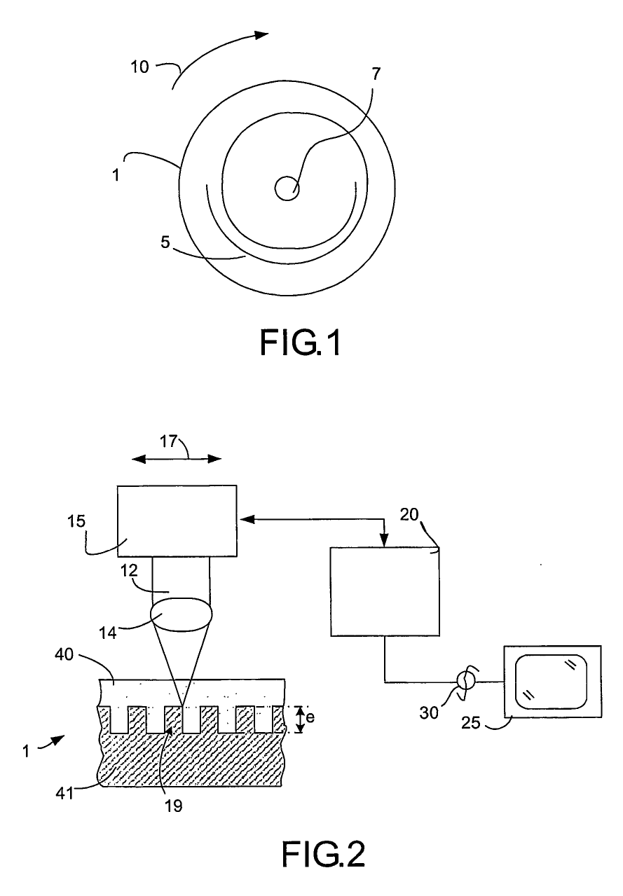

FIG. 1 shows an optical medium in accordance with the invention,

FIG. 2 shows an apparatus for reading and/or writing an optical medium viewed in cross-section,

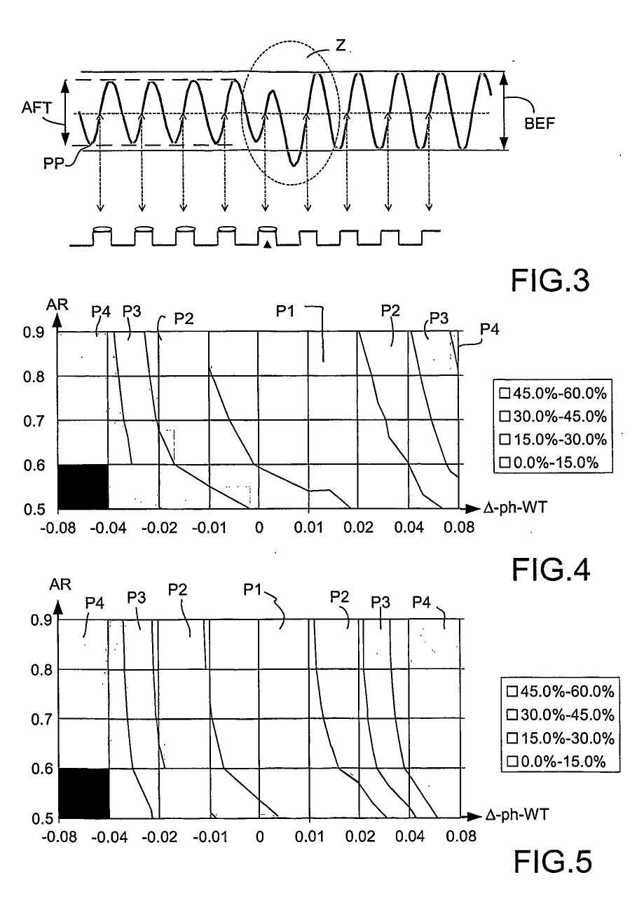

FIG. 3 shows the variations of the PP signals,

FIGS. 4 and 5 are diagrams used for choosing the relevant phase difference in accordance with the invention,

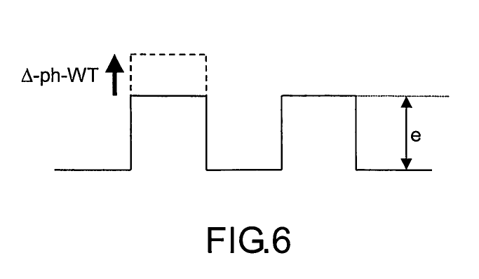

FIG. 6 shows the sign convention for a positive Δ-phase of the written track Δ-ph-WT with respect to the groove orientation.

FIG. 1 shows a medium 1 in accordance with the invention. This medium is an optical recording disc. On this disc is shown a track 5 in a helical form. This track is always provided on this kind of disc, even on a blank one. The medium rotates about a spindle, which passes through a hole 7, in a direction indicated by an arrow 10. Information can be stored along this track 5 in the form of marks (pits) and spaces (lands). It is important to follow this track with great accuracy. For this purpose, a servo is used for driving an optical head. This servo is controlled by a signal, which is called Push Pull (PP) signal. This signal is well known in the field of optical recording technology. The PP signal must be formed even for an optical disc in which no data are stored.

FIG. 2 shows an apparatus in which a medium 1 realized in accordance with the invention is placed. The medium 1 is shown in cross-section. On this medium, a laser light beam 12 is focused by a lens 14. The laser is mounted in a laser head 15 which can be moved in dependence on the control of electronic circuits 20, in directions indicated by the arrow 17. A servo, not shown, controls the laser beam so that the focused beam is always on or in the relevant grooves. The depth of the groove is “e”. In FIG. 2, a relevant groove has reference numeral 19. The direction of motion of the beam is perpendicular to the plane of FIG. 2. This electronic circuit 20 performs all the processing of reading and/or writing. A display unit 25 can be connected to a terminal 30 so that the content of the medium can be displayed. The medium shown in this FIG. 2 is constituted by two layers 40 and 41. The first layer 40 is a protective layer. The second layer 41 is used for the recording of data. Before writing commences, a virgin medium already has a groove for tracking. Said laser head is guided on this groove by means of the PP signals mentioned above.

FIG. 3 shows the variations in the amplitude of the PP signal. The amplitude of this signal is AFT for a region of a groove already written and becomes BEF for a region of a groove unwritten. There is a transition zone Z between these two regions. It is to be noted that the slope of this PP signal is also changed. The guiding of the head can be disturbed. The invention proposes to choose a material that reduces the amount of variations of the PP signal as much as possible.

FIG. 4 and FIG. 5 show the way in which the layers 40 and 41 are determined. FIG. 4 provides the variations of the amplitude of the PP signal and FIG. 5 the variation of the slope of this PP signal. The diagrams shown in these Figures are decomposed into portions P1, P2, P3 and P4:
P1 is related to a variation comprised between 0.0 and 15.0%
P2 is related to a variation comprised between 15.0 and 30.0%
P3 is related to a variation comprised between 30.0 and 45.0%
P4 is related to a variation comprised between 45.0 and 60.0%.

The x-coordinates are the Δ-phase of the written track Δ-ph-WT. The y-coordinates are the average reflection AR. For the definition of the sign convention relating to Δ-phase, see FIG. 6. Here it is seen that a positive phase corresponds to an increased groove depth.

Δ-ph-WT is the phase difference of a written track with respect to a non-written track. This phase difference is measured in units of the wavelength of the laser light.

AR is an approximation of the reflection coefficient of a written track normalized by the empty track reflection. For a rewritable phase-change medium, this approximation is based on the reflection coefficient of the crystalline and amorphous states:
AR=(r_{A}+r_{C})/r_{C}
in which r_{A} is the reflection coefficient of the anamorphous material and r_{C} is the reflection coefficient of the crystalline material.

In FIGS. 4 & 5, the portions indicated by PI are the most favorable for keeping the variations of the PP signals constant. It can be seen from FIG. 4 that with an average groove reflectivity of AR=0.5 the optimum phase difference Δ-ph-WT is in the range 0.02<Δ-ph-WT<0.06. When AR is increased to AR=0.6, the optimal phase difference Δ-ph-WT is in the region 0<Δ-ph-WT<0.04.

A material which is suitable for the invention is a phase-change growth-dominant material GeInSbTe, or any phase-change material based on the GeSb-system, with additives such as Te, In, Sb, Ag, Cu or anything else, i.e. both growth-and nucleation-dominant materials.

In fact, the material used is not important. The invention is effective for all rewritable optical mediums and for recordable mediums based on dyes, metal alloys, or phase-change technology.

The basic claim is the compensation of the reduction in reflection of the written grooves through addition of an additional phase to the written marks relative to the surrounding spaces and lands (according to FIGS. 4 and 5). The additional phase may be created by optimizing the stack design through a proper choice of the thickness of all layers and by using a phase-change material with the proper optical constants for both its amorphous and its crystalline state. It is possible to find an adequate depth of the groove to help satisfy these requirements.

For summing up:
the optical media may be formed by a material constituted of a phase-change growth-dominant material,
the material may be formed by a phase-change nucleation-dominant material,
the material may be formed by a recordable material,
the material may be formed by a recordable dye material,
the material may be formed by a recordable metal-alloy material,
the material may be formed by a recordable phase-change material,
the—optical medium, in which layers of material are provided, may be formed by a material that presents a positive phase difference between written track and unwritten track of between 0.0 wavelength and 0.08 wavelength if the average reflection coefficient is between 0.5 and 0.6, or presents a phase difference between written track and unwritten track of between −0.01 wavelength and 0.04 wavelength if the average reflection coefficient is greater than 0.6.

1. An optical medium in which a pre-groove track is embedded between layers of material for generating a tracking signal, characterized in that this material presents a slightly positive, weak variation in the phase between written track and unwritten track and an average reflection coefficient of an order of magnitude of 0.5 or greater.

2. An optical medium as claimed in claim 1, characterized in that the material is formed by a phase-change material.

3. An optical medium as claimed in claim 1, characterized in that the material is formed by a phase-change growth-dominant material.

4. An optical medium as claimed in claim 1, characterized in that the material is formed by a phase-change nucleation-dominant material.

5. An optical medium as claimed in claim 1, characterized in that the material is formed by a recordable material.

6. An optical medium as claimed in claim 1, characterized in that the material is formed by a recordable dye material.

7. An optical medium as claimed in claim 1, characterized in that the material is formed by a recordable metal-alloy material.

8. An optical medium as claimed in claim 1, characterized in that the material is formed by a recordable phase-change material.

9. An optical medium as claimed in claim 1, in which layers of material are provided, characterized in that this material presents a positive phase difference between written track and unwritten track between wavelengths of 0.0 and 0.08 if the average reflection coefficient is between 0.5 and 0.6.

10. An optical medium as claimed in claim 1 in which layers of material are provided, characterized in that this material presents a phase difference between written track and unwritten track wavelengths of −0.01 and 0.04 if the average reflection coefficient is greater than 0.6.

11. An apparatus for reading and/or writing an optical medium, the apparatus comprising an optical head for producing a light beam in the direction of said optical medium and electronic circuits for managing the reading/writing processes, the apparatus being characterized in that the optical medium is as claimed in claim 1.

12. A method of creating an optical medium as claimed in claim 1, characterized in that layers are placed on one another, and the material and the depth of the groove are chosen such that the optical medium presents a slightly positive weak variation in the phase between written track and unwritten track and an average reflection coefficient of an order of magnitude of 0.5 or greater.
